(19) United States
(12) Patent Application Publication
(10) Pub. No.: US 2014/0269404 A1
(43) Pub. Date: Sep. 18, 2014

(54) DETERMINING THE RELIABILITY OF COMMUNICATIONS BETWEEN A PORTABLE ELECTRONIC DEVICE AND AN ACCESS POINT

(71) Applicant: Apple Inc., Cupertino, CA (US)

(72) Inventors: Saravanan Balasubramaniyan, Cupertino, CA (US); Kapil Chhabra, Milpitas, CA (US); Tito Thomas, San Jose, CA (US)

(73) Assignee: Apple Inc., Cupertino, CA (US)

(21) Appl. No.: 13/893,131

(22) Filed: May 13, 2013

Related U.S. Application Data
(60) Provisional application No. 61/788,301, filed on Mar. 15, 2013.

(51) Int. Cl. H04W 24/08

(52) U.S. Cl. CPC H04W 24/08
USPC 370/253

(57) ABSTRACT

A method and system are described for determining the reliability of the communications between a portable electronic device and an access point (AP) before associating with the AP. In the described embodiments, a first probe request frame is transmitted to the AP at a first data rate, and a first probe response frame is received from the AP, wherein the first probe response frame is responsive to the first probe request frame. Then, a second probe request frame is transmitted to the AP at a second data rate, wherein the first data rate is lower than the second data rate. Then, the portable electronic device determines if a second probe response frame is received from the AP, wherein the second probe response frame is responsive to the second probe request frame. The portable electronic device then determines the reliability of the communications between the portable electronic device and the AP.

### RELATED APPLICATION

This application claims priority under 35 U.S.C. §119 to U.S. Provisional Application No. 61/788,301, entitled “Characterizing the Reliability of Transmissions Between a Portable Electronic Device and an Access Point,” by Saravanan Balasubramaniyan, Kapil Chhabra, and Tito Thomas, filed 15 Mar. 2013 (Atty. Docket No.: (APL-P13468USP1), the contents of which are herein incorporated by reference in their entirety.

### BACKGROUND

1. Field

The described embodiments relate to methods and an apparatus for characterizing a signal from a portable electronic device. More specifically, the described embodiments relate to determining the reliability of communications between a portable electronic device and an access point before associating with the access point.

2. Related Art

Portable electronic devices, such as smartphones, typically can send and receive data using a cellular data connection, and a wireless local area network (WLAN) connection through a access point (AP), which often uses IEEE 802.11 technology (e.g., a WiFi network). Users may have a limit to the amount of data that can be sent and received using the cellular data connection (e.g., monthly) without incurring additional expense, and therefore may desire to connect to a WLAN through an AP when it is possible. However, situations in which connecting to and/or communicating with the AP may be difficult or otherwise unreliable may result in a portable electronic device using more battery power than necessary to attempt to communicate with the AP and an unreliable WLAN connection that may lead to an undesirable user experience.

### BRIEF DESCRIPTION OF THE FIGURES

FIG. 1 presents a block diagram illustrating a portable electronic device in accordance with described embodiments.

FIG. 2 presents a block diagram illustrating a networking subsystem in accordance with described embodiments.

FIG. 3 presents a block diagram illustrating an operating system, applications and subsystems of a portable electronic device in accordance with described embodiments.

FIG. 4 presents a flowchart illustrating a process for determining the reliability of communications between a portable electronic device and an AP before associating with the AP in accordance with described embodiments.

FIG. 5A presents an exemplary diagram illustrating the asymmetry between the wireless coverage area for an AP and a portable electronic device in accordance with described embodiments.

FIG. 5B presents an exemplary diagram illustrating the range at which a given fraction (e.g., ½) of frames will be received for the various transmission data rates depicted in accordance with described embodiments.

FIG. 6 presents a flowchart illustrating another process for determining the reliability of communications between a portable electronic device and an AP before associating with the AP in accordance with described embodiments.

In the figures, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a portable electronic device with computing capabilities. For example, the computer-readable storage medium can include volatile memory or non-volatile memory, including flash memory, random access memory (RAM, SRAM, DRAM, RDRAM, DDR/DDR2/DDR3 SDRAM, etc.), magnetic or optical storage mediums (e.g., disk drives, magnetic tape, CDs, DVDs), or other mediums capable of storing data structures or code. Note that, in the described embodiments, the computer-readable storage medium does not include non-statutory computer-readable storage mediums such as transmission signals.

The methods and processes described in this detailed description can be included in hardware modules. For example, the hardware modules can include, but are not limited to, one or more application-specific integrated circuit (ASIC) chips, field-programmable gate arrays (FPGAs), other programmable-logic devices, dedicated logic devices, and microcontrollers. When the hardware modules are activated, the hardware modules perform the methods and processes included within the hardware modules. In some embodiments, the hardware modules include one or more general-purpose circuits that are configured by executing instructions (program code, firmware, etc.) to perform the methods and processes.

The methods and processes described in the detailed description section can be embodied as code and/or data that can be stored in a computer-readable storage medium as described above. When a device (e.g., a portable electronic device) with computing capabilities reads and executes the code and/or data stored on the computer-readable storage medium, the device performs the methods and processes embodied as data structures and code and stored within the computer-readable storage medium. For example, in some embodiments, a processing subsystem can read the code and/or data from a memory subsystem that comprises a computer-readable storage medium and can execute code and/or use the data to perform the methods and processes.

In the following description, we refer to “some embodiments.” Note that “some embodiments” may describe a subset of all of the possible embodiments, but does not always specify the same subset of embodiments.

### Overview

Described embodiments perform operations for determining the reliability of communications from a portable electronic device to an AP. A portable electronic device can be or include, but is not limited to, a smartphone, a tablet computer, a laptop computer, a netbook, or any portable device that includes a network subsystem that can scan for APs.

Typically a AP will have a higher power transmitter than a portable electronic device, and as a result, when the portable electronic device is suitably far from the AP, the portable electronic device may be able to reliably receive a signal transmitted from the AP, while the AP is not able to reliably receive a signal transmitted by the portable electronic device. Additionally, both APs and portable electronic devices can transmit signals that carry data at a variety of data rates, and for a given transmission power, a lower data rate signal can be reliably received over a longer distance than a high data rate signal. Therefore, for certain separations between a AP and a portable electronic device, at a given data rate a AP may be able to transmit data that can be reliably received by a portable electronic device, while data transmitted by the portable electronic device may not be reliably received by the AP. Furthermore, at a given separation, the AP may be able to transmit data that can be reliably received by the portable electronic device at a higher data rate than can be reliably received by the AP for data transmitted from the portable electronic device.

Generally, when a user wishes to connect to a WLAN, the portable electronic device may discover the presence of an AP either by passively listening for transmissions from the AP, such as beacon frames, or by actively searching for APs by transmitting frames such as probe frames and waiting for probe response frames from APs. However, as discussed above, since an AP typically transmits with a higher power than a portable electronic device, passively listening for APs to connect to may result in attempting to connect to an AP that is too distant to for the portable electronic device to reliably communicate with (e.g., to distant to reliably receive a transmission from the portable electronic device).

Note that typically when a portable electronic device sends out a probe request, it is sent out at a low data rate, often the lowest standard data rate of the wireless communication standard being used (e.g., 1 Mbps for the IEEE 802.11b amendment), so that the probe request frame can be reliably received over the longest distance possible (e.g., so that as many APs as possible receive the probe request). An AP receiving this probe request may then respond to the portable electronic device with a probe response frame. As noted above, the frame transmitted from the AP is typically transmitted at a higher power than that from the portable electronic device and is therefore more likely to be received. As a result, it may be the case that when the portable electronic device is far enough away from an AP, frames transmitted by the portable electronic device are not reliably received by the AP. If, however, the AP does happen to properly receive a frame, the response from the AP will be more likely to be received by the portable electronic device. Due to this asymmetry, a portable electronic device may attempt to associate with an AP that cannot reliably receive frames it has transmitted. This can result in wasting battery power by the portable electronic device as it attempts to find, associate, and/or communicate with an AP, and it may also result in a portable electronic device classifying a AP as a “rogue” AP, resulting in it not associating with the AP even when it can reliably do so.

Note that after a portable electronic device receives a probe response frame from an AP, typically the portable electronic device will then transmit an acknowledgment (ACK) frame to the AP. If the AP is far enough away from the portable electronic device, then there may be a chance that although the initial probe request frame was received, the ACK frame may not be received by the AP. In this case, the AP may then resend the probe response frame, and again await an ACK frame from the portable electronic device in response. The resent probe frame would have the retry bit set so that if it is received by the portable electronic device, the portable electronic device could infer that the original ACK had not been received, resulting in the AP resending the probe response frame.

During operation of described embodiments, when the portable electronic device scans for APs, it uses active scanning and sends out frames at different data rates. Since the frames sent out at different data rates will have different effective ranges at which they can be reliably received by a AP (e.g., the lower the data rate, the longer the effective range), the portable electronic device can use frames transmitted by the AP to determine the reliability of the communications between the portable electronic device and the AP even before the portable electronic device has associated with the AP. Note that reliability may be defined as desired for the given circumstances, and/or may be based on industry standard or convention. For example, in some embodiments reliability may mean that greater than 90% of the transmitted frames are received.

For example, a portable electronic device may scan for APs by sending out a probe request frame at the lowest available data rate (e.g., 1 Mbps data rate). Then, the AP responds with a probe response frame (also typically sent at the lowest data rate, e.g., 1 Mbps). As discussed above, the probe response frame from the AP is more likely to be received by the portable electronic device than the probe request frame transmitted by the portable electronic device is to be received by the AP. After the portable electronic device receives the probe response frame from the AP, the portable electronic device responds to the AP with an ACK frame. If the ACK frame is not received by the AP, then the AP may resend the probe response frame (with the retry bit set). When the portable electronic device receives this frame (with the retry bit set), then the portable electronic device can use this information to determine that the signal it is transmitting to the AP is not being reliably received. Note that the portable electronic device may also track the number of retries for a probe response frame from a AP by tracking the number of ACK frames that it sends in response to probe response frames from the AP which are sent by a AP in response to a single probe request frame.

The portable electronic device may then send another probe request frame to the AP at a higher data rate (e.g., at 2 Mbps). If this probe request frame is received by the AP, then as above, it will send a probe response frame. Note that since the effective range for the probe request frame at the higher data rate (e.g., 2 Mbps) is shorter than that for the lower data rate (e.g., 1 Mbps), if the higher data rate probe request frame is received by the AP and a probe response frame is sent by the AP, then the portable electronic device may use this information to determine that the reliability of communications between the portable electronic device and the AP is sufficient to allow association between the AP and the portable electronic device to proceed. In some embodiments, the portable electronic device may transmit one or more probe requests at each of two or more data rates, and then use the statistics of the received probe request responses and the retry bits (and/or number of retries) of each probe response frame to determine the reliability of communications between the portable electronic device and the AP.

In some embodiments, the portable electronic device may vary the data rate of the ACK frame instead of or in addition to varying the data rate of the probe request frame. The portable electronic device may then use the probe request responses, and the retry bit to determine which data rate ACK frames were received (e.g., reliably received). This information may then be used by the portable electronic device to determine the reliability of communications between the portable electronic device and the AP.

### Portable Electronic Device

FIG. 1 presents a block diagram illustrating portable electronic device 100 in accordance with described embodiments. Portable electronic device 100 includes processing subsystem 102, memory subsystem 104, and networking subsystem 106, all coupled together and communicating through bus 108.

Processing subsystem 102 includes one or more devices configured to perform computational operations. For example, processing subsystem 102 can include one or more microprocessors, application-specific integrated circuits (ASICs), microcontrollers, application processors, and/or programmable-logic devices.

Memory subsystem 104 includes one or more devices for storing data and/or instructions for processing subsystem 102, and networking subsystem 106. For example, memory subsystem 104 can include any type of computer-readable storage medium, such as dynamic random access memory (DRAM), static random access memory (SRAM), and/or other types of memory. In addition, memory subsystem 104 can include mechanisms for controlling access to the memory. In some embodiments, memory subsystem 104 includes a memory hierarchy that comprises one or more caches coupled to a memory in portable electronic device 100. In some of these embodiments, one or more of the caches is located in processing subsystem 102.

In some embodiments, memory subsystem 104 is coupled to one or more high-capacity mass-storage devices (not shown). For example, memory subsystem 104 can be coupled to a magnetic or optical drive, a solid-state drive, or another type of mass-storage device. In these embodiments, memory subsystem 104 can be used by portable electronic device 100 as fast-access storage for often-used data, while the mass-storage device is used to store less frequently used data.

Networking subsystem 106 includes one or more devices configured to couple to and communicate on a wired and/or wireless network (i.e., to perform network operations), including one or more cellular subsystems that may include cellular data and/or cellular voice subsystems that communicate on cellular networks (e.g., a 3G/4G network such as 1x, UMTS, LTE, etc.), and a WLAN subsystem for communicating on a WLAN network, including portions based on standards described in IEEE 802.11 (such as a Wi-Fi networking system). Networking subsystem 106 can include a Bluetooth networking subsystem, a universal serial bus (USB) networking subsystem, an Ethernet networking subsystem, and/or other networking subsystems. Networking subsystem 106 will be discussed in more detail below with respect to FIG. 2.

Processing subsystem 102, memory subsystem 104, and networking subsystem 106 are coupled together using bus 108. Bus 108 is an electrical, optical, or electro-optical connection that the subsystems can use to communicate commands and data among one another. Although only one bus 108 is shown for clarity, different embodiments can include a different number or configuration of electrical, optical, or electro-optical connections among the subsystems.

Although shown as separate subsystems in FIG. 1, in some embodiments, some or all of a given subsystem can be integrated into one or more of the other subsystems in portable electronic device 100. Although alternative embodiments can be configured in this way, for clarity we describe the subsystems separately.

Portable electronic device 100 can be (or can be included in) any device with at least one processing subsystem and one networking subsystem. For example, portable electronic device 100 can be (or can be included in) a laptop computer, a media player, a subnotebook/netbook, a tablet computer, a cellular phone, a personal digital assistant (PDA), a smartphone, a toy, a controller, or another device.

Portable electronic device 100 may also include one or more additional processing subsystems 102, memory subsystems 104, and/or networking subsystems 106. Furthermore, although we use specific subsystems to describe portable electronic device 100, in alternative embodiments, portable electronic device 100 may include one or more additional subsystems that are not shown in FIG. 1. For example, portable electronic device 100 may also include, without limitation, a data collection subsystem, an alarm subsystem, an audio subsystem, a display subsystem and/or an input/output (I/O) subsystem. For example, portable electronic device 100 may include a display subsystem which can include any type of display technology, such as light-emitting diode (LED), organic light-emitting diode (OLED), liquid crystal display (LCD) (such as thin film transistor (TFT), and/or other types of display technology. In addition, the display subsystem may include mechanisms for processing data, and/or other information for display and may also include an audio subsystem for producing sound. The display subsystem may also include touch screen technology for inputting information into portable electronic device 100. In some embodiments, one or more memory caches and/or processing systems or other hardware modules may be located in the display subsystem. Furthermore, portable electronic device 100 may contain a battery subsystem that includes one or more rechargeable batteries that can be used to provide power for one or more of the subsystems in portable electronic device 100.

### Networking Subsystem

FIG. 2 presents a block diagram illustrating a networking subsystem in accordance with described embodiments. Networking subsystem 106 includes processing subsystem 202 and memory subsystem 204. Networking subsystem 106 also includes controllers, radios/antennas, sockets/plugs, and/or other devices used for coupling to, communicating on, and handling data and events for each supported networking system, including communicating with APs and on WLANs implementing 802.11 technology.

Processing subsystem 202 may include one or more devices configured to perform computational operations. For example, processing subsystem 202 can include one or more microprocessors, application-specific integrated circuits (ASICs), microcontrollers, application processors, ARM processors, and/or programmable-logic devices.

Memory subsystem 204 includes one or more devices for storing data and/or instructions for processing subsystem 202, and other data or information received by and/or for transmission by networking subsystem 106. Memory subsystem 204 can include any type of computer-readable storage medium such as dynamic random access memory (DRAM), static random access memory (SRAM), and/or other types of memory. In addition, memory subsystem 204 can include mechanisms for controlling access to the memory. Additionally, memory subsystem 204 may include firmware and/or software or other data and instructions used by networking subsystem 106 to manage, communicate and perform other processes as described herein using networking subsystem 106.

### Operating System

FIG. 3 presents a block diagram illustrating operating system 302 in accordance with the described embodiments. In some embodiments, operating system 302 is stored (as program code) in memory subsystem 104 and executed by processing subsystem 102.

Generally, operating system 302 serves as an intermediary between system hardware in portable electronic device 100 (e.g., subsystems 102-106) and applications executed by processing subsystem 102, such as applications 304-306 (which can be, for example, an email application, a web browser, a text messaging application, a voice communication application, an alarm application, and/or a game application). For example, operating system 302 can be, but is not limited to, the iOS operating system or OS X operating system, both from Apple Inc. of Cupertino, Calif.; Windows Phone from Microsoft Corporation; Android from the Open Handset Alliance; the FreeBSD operating system from The FreeBSD Foundation of Boulder, Colo.; or another operating system. Operating systems and their general functions are known in the art and hence are not described in detail.

To manage the transfer of packets to and from applications 304-306 and operating system 302 in portable electronic device 100 using an appropriate interface in networking subsystem 106, operating system 302 maintains one or more network protocol stacks (not shown) that each includes a number of logical layers. For example, the operating system can maintain a cellular protocol stack and/or an Internet protocol stack, which includes the link, Internet, transport, and application layers. As another example, the operating system can maintain a protocol stack based on the OSI model, which includes the application, presentation, session, transport, network, data-link, and physical layers. At corresponding layers of the protocol stack, the operating system includes control mechanisms and data structures for performing the functions associated with the layer. The functions associated with each of the layers in the protocol stack are known in the art and hence are not described in detail.

Operating system 302 may also include one or more drivers that enable applications 304-306 and/or other software such as operating system 302 to communicate and/or control hardware in portable electronic device 100. For example, operating system 302 may include driver software that enables application 304 to use, and/or control networking subsystem 106. Note that in some embodiments, a driver may be implemented as an application separate from operating system 302, while in other embodiments, the driver may be loaded into or otherwise incorporated into operating system 302.

### Determining the Reliability of Communications

FIG. 4 presents a flowchart illustrating a process for determining the reliability of communications between a portable electronic device and an AP before associating with the AP in accordance with described embodiments. The operations shown in FIG. 4 may be performed by a portable electronic device, such as portable electronic device 100, and in some embodiments, may be performed by a processing subsystem in the portable electronic device such as processing subsystem 102 and/or processing subsystem 202. Additionally, programming and/or other code and instructions for performing the operations shown in FIG. 4, and/or data, statistics and other information about transmitted and received frames and data rates may be stored in memory in the portable electronic device such as memory subsystem 104 and/or memory subsystem 204.

The process of FIG. 4 may begin when a portable electronic device 100 scans for APs (step 402). This may occur, for example, when a user with a smartphone enters a mall, an airport, or nears a home or workplace AP and portable electronic device 100 scans for APs using networking subsystem 106 on its own or based on input from a user.

Scanning for APs may begin with portable electronic device 100 controlling networking subsystem 106 to start on one WLAN channel (e.g., the channel of a known AP, or starting at the first of a set of WLAN channels to be scanned). At step 404, portable electronic device 100 sets the data rate for the probe request frame to a predetermined value. For example, portable electronic device 100 may initially set the data rate for the probe request frames to the minimum data rate available, which may depend on factors including the broadcast frequency (e.g., 2.4 GHz or 5 GHz) and/or the standard being used (e.g., the 802.11 amendment). In some embodiments, the minimum data rate may be set to 1 Mbps. Note that the data rate for frames transmitted by portable electronic device 100 may generally be set in any way, including by operating system 302 using a driver to communicate with firmware stored in memory subsystem 204 of networking subsystem 106.

Then, at step 406, portable electronic device 100, using networking subsystem 106, transmits a probe request frame at the current data rate (e.g., at the minimum available data rate). Networking subsystem 106 then listens for probe response frames sent by an AP in response to the probe request frame transmitted by portable electronic device 100 and collects information related to the received probe response frames (step 408). For example, at step 408, networking subsystem 106 may collect statistics including, but not limited to, information related to the transmitted probe request frames, received probe response frames, retry bit settings for each received probe response frame, how many probe response frames were received in response to each probe request frame, the data rate of each frame transmitted and received, and the identity of the AP(s) transmitting and receiving frames from the portable electronic device.

Then at step 410, if portable electronic device 100 determines that it should transmit another probe request at the current predetermined data rate, the process returns to step 406. Portable electronic device 100 may determine that an additional probe request frame should be transmitted based on information including the number of probe request frames already transmitted (at the current default data rate, and at other data rates), and the number of response frames received with the retry bit set. For example, operating system 302 may use a driver to transmit control information to memory subsystem 204 (e.g., firmware in networking subsystem 106) to control networking subsystem 106 to transmit a minimum number, up to a maximum number of probe request frames based on the number of probe response frames that contain a set retry bit (e.g., transmit at least 3 but up to 5 probe request frames depending on the number of probe responses that have the retry bit set). In some embodiments, networking subsystem 106 may be controlled to transmit a predetermined number of probe request frames at each data rate (e.g., 5).

At step 410, if another probe request is not going to be sent at the current data rate, then the process continues to step 412. At step 412 if portable electronic device 100 has not finished sending probe requests at all desired data rates, then the process continues to step 414, where a new data rate is set, and the process returns to step 406. In some embodiments, portable electronic device 100 may determine that networking subsystem 106 should send probe request frames at the lowest and second lowest common data rate (e.g., 1 Mbps, and 5.5 Mbps) for portable electronic device 100 and the AP it is communicating with.

At step 412, if the desired number of probe request frames has been sent at each of the desired data rates, then the process continues to step 416. At step 416, portable electronic device 100 determines the reliability of communications between the AP and the portable electronic device based on the information collected about the probe response frames, the data rates, and the number of retries. Determining the reliability may include, but is not limited to, determining the rate at which frames transmitted by portable electronic device 100 are received by the AP, and may additionally include comparing this rate and/or other information collected to a predetermined rate or set of information which is used by portable electronic device 100 to determine the reliability. For example, portable electronic device 100 may determine that if 4 or more out of 5 frames at 1 Mbps, and 3 or more out of 5 frames at 5.5 Mbps are received by an AP with no more than 1 retry, then communications between portable electronic device 100 and the AP are reliable. Note that the process depicted in FIG. 4 may be performed on one or more WLAN channels.

FIG. 5A presents an exemplary diagram illustrating the asymmetry between the wireless coverage area for an AP and a portable electronic device in accordance with described embodiments. As depicted in FIG. 5A, AP 502 has AP coverage area 504. AP coverage area 504 is the distance from AP 502 at which frames can be reliably received by portable electronic device 100 at a given data rate. Portable electronic device 100 has portable electronic device coverage area 506 which is the distance at which AP 502 can reliably receive frames from portable electronic device 100 at the given data rate. Note that for the same data rate, the distance at which frames transmitted by AP 502 can be reliably received by portable electronic device 100 is longer than the distance at which frames transmitted by portable electronic device 100 can be reliably received by AP 502. Additionally, note that the coverage areas are depicted as uniform circles for convenience, but the coverage areas may be of any shape and may be influenced by factors including, but not limited to, obstacles, and the orientation and placement of the antennas for both AP 502 and portable electronic device 100.

FIG. 5B presents an exemplary diagram illustrating the range at which, on average, a given fraction (e.g., ½) of frames will be received for the various transmission data rates depicted in accordance with described embodiments. AP range 508 is depicted as dotted circles representing the range for frames transmitted by AP 502 at 1 Mbps, 5.5 Mbps, and 11 Mbps, and portable electronic device range 510 is depicted as solid circles representing the range for frames transmitted by portable electronic device 100 at 1 Mbps and 5.5 Mbps. Note that portable electronic device 100 is well inside the range to receive frames from AP 502 that are transmitted at 1 Mbps and, therefore, can likely reliably receive frames from AP 502 at this data rate, but portable electronic device 100 is only a bit inside the range to receive frames from AP 502 at 5.5 Mbps and, therefore, may only receive a fraction of the frames sent by AP 502 at this data rate (e.g., slightly more than ½). Thus, frames sent by AP 502 to portable electronic device 100 at 1 Mbps may be reliably received, while only about half of the frames sent at 5.5 Mbps will get through.

FIG. 5B also depicts the range at which frames transmitted by portable electronic device 100 can be received by AP 502 at 1 Mbps and 5.5 Mbps. Note that AP 502 is only a bit inside the range to receive frames from portable electronic device 100 at a 1 Mbps data rate and, therefore, may only receive a fraction of the frames transmitted at this data rate (e.g., ¾), and will likely receive none (or a very small fraction) of the frames transmitted at 5.5 Mbps.

Now, returning to the process of FIG. 4, portable electronic device 100 may determine that it should send data frames at 1 Mbps and 5.5 Mbps, and then based on the received probe response frames, data rates and number of retries, determine the reliability of communications to AP 502. Then, based on this determination, portable electronic device 100 may determine if a reliable connection can be established and whether or not it should associate with AP 502. For example, using the process of FIG. 4, portable electronic device 100 may transmit 5 probe request frames at 1 Mbps and 5 probe request frames at 5.5 Mbps. Since a fraction (e.g., ¾) of the frames transmitted by portable electronic device 100 at 1 Mbps will be received by AP 502, that means that on average 3 out of 5 frames transmitted at 1 Mbps may be received by AP 502. AP 502 will respond to portable electronic device 100 with probe response frames for each of the received probe request frames. The frames transmitted by AP 502 to portable electronic device 100 will be reliably received, since portable electronic device 100 is well within the 1 Mbps range of AP 502.

When portable electronic device 100 receives each probe response frame, it will send an ACK frame to AP 502 to acknowledge that the frame has been received. Since only a fraction of the frames sent by portable electronic device 100 to AP 502 are received (e.g., ¾), it may be the case that in some circumstances, one or more of the ACK frames is not received by AP 502 and therefore AP 502 retransmits the probe response frame (with the retry bit set). When portable electronic device 100 receives a probe response frame with the retry bit set, it can determine that the ACK frame was not received.

The same process is repeated at a data rate of 5.5 Mbps, and since as depicted in FIG. 5B, AP 502 is well outside the range of portable electronic device 100 at this data rate, it is possible that none of the probe request frames will be received by AP 502. Even if a frame does happen to be received and AP 502 transmits a probe response frame, it is unlikely that the ACK frame from portable electronic device 100 will also be received (at least not without potentially multiple retries).

Portable electronic device 100 then uses information including the data rates of the probe request frames and the resulting number of probe response frames (and retries) received from AP 502 to determine the reliability of communications from portable electronic device 100 to AP 502. For example, portable electronic device 100 may determine that based on receiving probe response frames from AP 502 for only 3 of 5 probe request frames sent at 1 Mbps and receiving no probe response frames (or only one) in response to probe request frames sent at 5.5 Mbps, that the communications between portable electronic device 100 and AP 502 are not reliable.

In some embodiments, portable electronic device 100 may require a predetermined fraction (e.g., 4 of 5) of probe request frames transmitted to AP 502 to result in probe response frames being transmitted at a given frequency for portable electronic device 100 to determine that the communications are reliable (e.g., transmitted frames are being reliably received). Additionally, portable electronic device 100 may further require that a fraction of the frames transmitted at a higher data rate, for example, the next higher data rate (i.e., 5.5 Mbps in this example) be received to determine that the lower data rate as reliable. For example, portable electronic device 100 may determine that communications with AP 502 are not reliable if fewer than a certain number or fraction of transmitted probe request frames result in probe response frames at a second lowest common data rate (e.g., 5.5 Mbps) even if probe response frames are received for a high number or fraction of probe request frames sent at the lowest common frequency (e.g., 1 Mbps). Portable electronic device 100 may use this information to determine that communications with AP 502 will not be reliable; therefore, it will not associate with AP 502 and/or display it as an associated AP or as an available AP for a user to associate portable electronic device 100 to.

In some embodiments, portable electronic device 100 may determine the number of frames to send at each data rate interactively based on information including the number or fraction of probe request frames that result in a probe response frame being sent from AP 502, and the retry bit setting of the received probe response frames. Additionally, portable electronic device 100 may first send probe request frames at a data rate higher (e.g., 5.5. Mbps) than the lowest common data rate (e.g., 1 Mbps) and based on information from the probe response frames, determine whether or not to send frames at the lowest common data rate, and if so, how many and what information from the probe response frames will result in portable electronic device 100 determining that communications with AP 502 are reliable. For example, if AP 502 does not respond to enough or a high enough fraction of the probe request frames at the second highest data rate, and/or there are too many retries (e.g., if the ACK frames are also sent at the higher data rate), then portable electronic device 100 may determine that communications with AP 502 are not reliable.

Additionally, note that the number or fraction of probe request frames that an AP must respond to in order for portable electronic device 100 to determine that is the communications are reliable and/or display information about the AP for a user may be based on testing using APs similar to those expected to be encountered, and/or data gathered from connections portable electronic device 100 has made with APs and the statistics of the probe request, response, retry bits, and data rates of the relevant frames. Additionally, portable electronic device 100 may also gather such information for specific APs (e.g., a home or work AP) and use this information to determine when a reliable communications can be established with these specific APs.

FIG. 6 presents a flowchart illustrating another process for determining the reliability of communications between a portable electronic device and a AP before associating with the AP in accordance with described embodiments. The operations shown in FIG. 6 may be performed by a portable electronic device, such as portable electronic device 100, and in some embodiments, may be performed by a processing subsystem in the portable electronic device such as processing subsystem 102 and/or processing subsystem 202. Additionally, programming and/or other code and instructions for performing the operations shown in FIG. 6, and/or data, statistics and other information about transmitted and received frames and data rates may be stored in memory in the portable electronic device such as memory subsystem 104 and/or memory subsystem 204.

The process of FIG. 6 may begin when portable electronic device 100 scans for APs (step 602). This may occur, for example, when a user carrying portable electronic device 100 enters a mall or an airport, or nears a home or workplace AP and portable electronic device 100 scans for APs using networking subsystem 106 on its own or based on input from the user.

Scanning for APs may begin with portable electronic device 100 controlling networking subsystem 106 to start on one WLAN channel (e.g., the channel of a known AP, or the first of a set of WLAN channels to be scanned). At step 604, portable electronic device 100 sets the data rate for the probe request frames and the ACK frames each to a start value. For example, portable electronic device 100 may initially set the data rate for the probe request frames to a high data rate, which may depend on factors including the broadcast frequency (e.g., 2.4 GHz or 5 GHz) and/or the standard being used (e.g., the 802.11 amendment). Portable electronic device 100 may also set the data rate of the ACK frame to the same high data rate. In some embodiments, the data rate may be set to 11 Mbps. Note that as discussed above, the data rate for frames transmitted by portable electronic device 100 may generally be set in any way, including by operating system 302 using a driver to communicate with firmware stored in memory subsystem 204 of networking subsystem 106.

Then, at step 606, portable electronic device 100, using networking subsystem 106, transmits a probe request frame at the current data rate. Networking subsystem 106 then listens for probe response frames sent by a AP in response to the probe request frame transmitted by portable electronic device 100 (step 608). If a probe response frame is not received, then the process goes to step 626, but if a probe response frame is received, then the process continues to step 610.

At step 610, portable electronic device 100 sends an ACK frame to the AP at the current ACK frame data rate to acknowledge the receipt of the probe response frame and also collects information related to the received probe response frame(s). At step 610, portable electronic device 100 (e.g., using networking subsystem 106) may collect statistics including, but not limited to, information related to the transmitted probe request frames, received probe response frames, retry bit settings for each received probe response frame, how many probe response frames were received in response to each probe request frame, the data rate of each frame transmitted and received, and the identity of the AP(s) transmitting and receiving frames from the portable electronic device, the number and data rate of each ACK frame transmitted and whether or not it was successfully received by the AP.

Then, at step 612, if the ACK frame was not received by the AP, the process continues to step 614. If the ACK frame was sent at the lowest data rate, for example, the lowest common data rate for both portable electronic device 100 and the AP (e.g., 1 Mbps), then the process continues to step 618. At step 614, if the ACK frame was not sent at the lowest data rate, then the process continues to step 616, and the ACK data rate is lowered to the next lower data rate from the current data rate (e.g., from 11 Mbps to 5.5 Mbps). The process continues to step 610, and when the next probe response frame is received (e.g., with the retry bit set because the previous ACK frame was not received by the AP), portable electronic device 100 transmits an ACK frame at the now lower data rate, (e.g., 5.5 Mbps in this example). Note that in some embodiments, portable electronic device 100 may send more than one ACK frame at each data rate if previous ACK frame(s) were not received. For example, if an ACK frame at 5.5 Mbps was not received by the AP, portable electronic device 100 may send the next ACK frame at 5.5 Mbps also, and if that one is not received, then send the next ACK frame at a lower data rate (e.g., 1 Mbps).

At step 612, if the ACK frame was received by the AP, then the process continues to step 618. If portable electronic device 100 determines that it should transmit another probe request at the current data rate, then the process continues to step 620 where the ACK frame data rate is reset to the start value, and then the process returns to step 606. Note that the start value of the data rate for the ACK frame is the current data rate of the probe request frame that will be transmitted at step 606.

At step 618, portable electronic device 100 may determine that an additional probe request frame should be transmitted based on information including the number of probe request frames already transmitted (at the current default data rate, and at other data rates), the number of ACK frames sent (and the data rates at which they were sent), and/or the number of response frames received with the retry bit set. For example, operating system 302 may use a driver to transmit control information to memory subsystem 204 (e.g., firmware in networking subsystem 106) to control networking subsystem 106 to transmit a minimum number, up to a maximum number of probe request frames based on the number of ACK frames sent, but not received, at the same data rate as the probe request frame. In some embodiments, networking subsystem 106 may be controlled to transmit a predetermined number of probe request frames at each data rate (e.g., 5) independent of the number of ACK frames sent or the probe response retries.

At step 618, if another probe request is not going to be sent at the current data rate, then the process continues to step 622. At step 622, if portable electronic device 100 has not finished sending probe request frames at all desired data rates, then the process continues to step 624, where a new probe request frame data rate is set, and the process then continues to step 620 and resets the ACK frame data rate as described above (e.g., setting it to the new probe request data rate). The process then returns to step 606. In some embodiments, portable electronic device 100 may determine that networking subsystem 106 should send probe request frames at each data rate available that is lower than the start data rate set at step 604. In some embodiments, portable electronic device 100 may determine that the communications between portable electronic device 100 and the AP can already be determined to be reliable and, therefore, no further probe request frames need to be transmitted. For example, if portable electronic device 100 determines that based on the data rates of probe request frames already sent and the data rates of the ACK frames that have been successfully received by the AP, that the communications can be determined to be reliable.

At step 622, if the desired number of probe request frames has been sent at each of the desired data rates, then the process continues to step 626 and the reliability of the communications between portable electronic device 100 and the AP is determined. At step 626, portable electronic device 100 may determine the reliability of communications between the AP and portable electronic device 100 based on the information collected about the probe response frames, the ACK frames, their respective data rates, and the number of retries. As discussed above, determining the reliability may include, but is not limited to, determining the rate at which frames transmitted by portable electronic device 100 are received by the AP, and may additionally include comparing this rate and/or other information collected to a predetermined rate or set of information which is used by portable electronic device 100 to determine the reliability.

In some embodiments, portable electronic device 100 may start at the lowest common data rate at step 604 (e.g., 1 Mbps) and then at step 624, increase to the next higher data rate, and continue this process until the probe request frames are at a data rate that is high enough that the probe request frames are no longer being received, or that it can be determined that the transmissions are being reliably received by the AP. Additionally, in some embodiments, portable electronic device 100 may start at a higher data rate (e.g., 11 Mbps) at step 604 and then step the data rate down at step 624. Then, when the probe request frames are received by the AP, the ACK frames will be sent at a decreasing data rate (at step 610) so that a reliable data rate can be found (if any).

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for determining a reliability of communications between a portable electronic device and an access point (AP), the method comprising:
the portable electronic device transmitting a first probe request frame to the AP at a first data rate;
the portable electronic device receiving a first probe response frame from the AP, wherein the first probe response frame is responsive to the first probe request frame;
the portable electronic device transmitting a second probe request frame to the AP at a second data rate, wherein the first data rate is lower than the second data rate;
the portable electronic device determining if a second probe response frame is received from the AP, wherein the second probe response frame is responsive to the second probe request frame; and
the portable electronic device determining the reliability of the communications based on whether or not the second probe response frame is received from the AP.

2. The method of claim 1, wherein determining the reliability includes determining the reliability based on information including:
a number of retries for the first probe response frame, wherein the number of retries for the first probe response frame is determined based on a number of probe response frames received with a retry bit set that are responsive to the first probe request frame; and
if the second probe response frame is received, a number of retries for the second probe response frame, wherein the number of retries for the second probe response frame is determined based on a number of probe response frames received with a retry bit set that are responsive to the second probe request frame.

3. The method of claim 2, further including:
displaying information related to the AP based on the determination of the reliability.

4. The method of claim 2, further including:
displaying information related to the AP only if the second data rate is above a predetermined data rate.

5. The method of claim 1, further including:
updating a list of available APs based on the determination of the reliability.

6. The method of claim 2, further including:
displaying information related to the AP only if the number of retries for the second probe response frame is less than a predetermined amount.

7. The method of claim 1, further including:
transmitting a set of probe request frames to the AP, wherein the set of probe request frames includes the first probe request frame and the second probe request frame;
receiving a set of probe response frames from the AP, wherein the set of probe response frames includes the first probe response frame and the second probe response frame, wherein received frames in the set of received frames are received from the AP and are responsive to transmitted frames in the set of transmitted frames; and
displaying information related to the AP only if a ratio between probe request frames at the second data rate and probe response frames at the second data rate is greater than or equal to a predetermined ratio.

8. A non-transitory computer-readable storage medium containing instructions that, when executed by a portable electronic device, cause the portable electronic device to perform a method for determining a reliability of communications between a portable electronic device and an access point (AP) before associating with the AP, the method comprising:
transmitting a first frame to the AP at a first data rate;
receiving a second frame from the AP, wherein the second frame is responsive to the first frame;
transmitting a third frame to the AP at a second data rate, wherein the first data rate is lower than the second data rate;
determining if a fourth frame is received from the AP, wherein the fourth frame is responsive to the third frame; and
determining the reliability based on information related to the first data rate and the second frame and the second data rate and the determination of if the fourth frame is received from the AP.

9. The non-transitory computer-readable storage medium of claim 8, wherein the information includes a number of retries for the second frame and, if the fourth frame is received, a number of retries for the fourth frame.

10. The non-transitory computer-readable storage medium of claim 9, further including:
displaying information related to the AP based on the determination of the reliability.

11. The non-transitory computer-readable storage medium of claim 9, further including:
displaying information related to the AP only if the second data rate is above a predetermined data rate.

12. The non-transitory computer-readable storage medium of claim 8, wherein:
the first frame is a probe request frame;
the second frame is a probe response frame;
the third frame is a probe request frame;
the fourth frame is a probe response frame; and
further including displaying information related to the AP only if the second data rate is above a predetermined data rate.

13. The non-transitory computer-readable storage medium of claim 8, wherein:
the first frame is a probe request frame;
the second frame is a probe response frame; and
the third frame is an acknowledgment (ACK) frame;
the fourth frame is a probe response frame.

14. The non-transitory computer-readable storage medium of claim 13, further including:
displaying information related to the AP only if a number of retries for the fourth frame is less than a predetermined amount.

15. The non-transitory computer-readable storage medium of claim 8, further including:
transmitting a first set of frames to the AP, wherein the first set of frames includes the first frame and the third frame;
receiving a second set of frames from the AP, wherein the second set of frames includes the second frame and the fourth frame, wherein frames in the second set of frames are received from the AP and are responsive to frames in the first set of frames; and
displaying information related to the AP only if a ratio between frames in the first set of frames at the second data rate and frames in the second set of frames at the second data rate is greater than or equal to a predetermined ratio.

16. An apparatus that determines a reliability of communications between a portable electronic device and an access point (AP) before associating with the AP, comprising:
a battery;
a processing subsystem coupled to and powered by the battery; and
a networking subsystem coupled to the processing subsystem and to the battery and configured to:
transmit a first frame to the AP at a first data rate;
receive a second frame from the AP, wherein the second frame is responsive to the first frame;
transmit a third frame to the AP at a second data rate, wherein the first data rate is lower than the second data rate;
receive a fourth frame from the AP after transmitting the third frame; and
wherein the processing subsystem is configured to determine the reliability based on information related to the first data rate and the second frame and the second data rate and the fourth frame.

17. The apparatus of claim 16, further including:
a display coupled to the networking subsystem and powered by the battery, wherein the information includes a number of retries for the second frame and a number of retries for the fourth frame, and the processing subsystem is configured to send information related to the AP to the display only if the number of retries for the fourth frame is less than a predetermined number.

18. The apparatus of claim 16, wherein:
the first frame is a probe request frame;
the second frame is a probe response frame;
the third frame is a probe request frame; and
the fourth frame is a probe response frame.

19. The apparatus of claim 16, wherein:
the first frame is a probe request frame;
the second frame is a probe response frame;
the third frame is an acknowledgment (ACK) frame;
the fourth frame is a probe response frame; and
the processing subsystem is further configured to:
determine the reliability based on a number of retries for the fourth frame.

20. The apparatus of claim 16, wherein:
the network subsystem is further configured to:
transmit a first set of frames to the AP, wherein the first set of frames includes the first frame and the third frame;
receive a second set of frames from the AP, wherein the second set of frames includes the second frame and the fourth frame; and
the processing subsystem is further configured to determine the reliability based on information including a ratio between transmitted frames in the first set of frames at the second data rate and received frames in the second set of frames at the second data rate.
